(19) United States
(12) Patent Application Publication
(10) Pub. No.: US 2009/0188239 A1
(43) Pub. Date: Jul. 30, 2009

(54) SYSTEM AND METHOD FOR REGENERATING A CATALYTIC PARTICULATE FILTER LOCATED IN A DIESEL ENGINE EXHAUST LINE

(75) Inventors: Violaine Ploton, Fontaine La Riviere (FR); Nicolas Thouvenel, Ballancourt (FR)

Correspondence Address: OBLON, SPIVAK, MCCLELLAND MAIER & NEUSTADT, P.C., 1940 DUKE STREET, ALEXANDRIA, VA, 22314, US

(73) Assignee: Renault S.A.S., Boulogne Billancourt (FR)

(21) Appl. No.: 12/067,311

(22) PCT Filed: Sep. 8, 2006
(86) PCT No.: PCT/FR06/50858

§ 371 Date: Aug. 4, 2008

(30) Foreign Application Priority Data
Sep. 23, 2005 (FR) 0509732

(51) Int. Cl. F01N 9/00; F01N 3/00; F01N 3/035; G01M 15/04

(52) U.S. Cl. 60/286; 60/295; 60/297; 73/114.51

(57) ABSTRACT

A system for regenerating a catalytic particulate filter located in a diesel engine exhaust line, including an electronic control unit, a controlled fuel injector arranged upstream of the catalytic particulate filter and supplied with fuel by a controlled pump, and a sensor for measuring the fuel feeding pressure of the injector. Further, a detection mechanism detects an open position locking of the injector based on the fuel feeding pressure of the injector.

The present invention relates to a system and to a method for regenerating a catalytic particulate filter located in the exhaust line of a diesel engine.

A catalytic particulate filter traps particles of soot emitted by the engine. To prevent the filter from becoming blocked, periodic regeneration phases burn off the trapped particles. The trapped particles are burnt off by increasing the temperature of the exhaust gases.

Systems for regenerating catalytic particulate filters by injecting fuel into the exhaust already exist, as described for example in application FR 2 796 985 (Renault) and the French patent application filed under the number 04 53187 (Renault). The fuel is injected by means of a fuel injector located in the exhaust line of a diesel engine upstream of the catalytic particulate filter. Systems such as this for regenerating a catalytic particulate filter present new risks should they fail. However, those documents do not disclose any monitoring of the injector located in the exhaust line.

One object of the invention is to check that the injector located in the exhaust line of the vehicle is operating correctly.

Thus, according to one aspect of the invention, there is proposed a system for regenerating a catalytic particulate filter located in the exhaust line of a diesel engine. The system comprises an electronic control unit, a controlled fuel injector located upstream of the catalytic particulate filter and supplied with fuel by a controlled pump, and a sensor for measuring the pressure at which said injector is supplied with fuel. The system further comprises means of detecting that said injector is stuck in the open position on the basis of the pressure at which said injector is supplied with fuel.

In other words, the detection means detect a fault with the operation of the injector when it is supposed to close but remains stuck open. It is then possible to detect defective operation of such a catalytic particulate filter regeneration system and thus be able to avoid failure of such a system.

The invention makes it possible to improve the safety of the occupants of the vehicle by detecting a fault with the injector located upstream of the catalytic particulate filter.

In a preferred embodiment, said detection means comprise time determining means for determining the time it takes for the pressure at which said injector is supplied with fuel to drop from a predetermined upper pressure to a predetermined lower pressure.

It is possible to detect that the injector is stuck in the open position from the time it takes for the pressure to drop by the predetermined amount when the feed pump is deactivated.

Advantageously, said detection means comprise time comparison means for comparing said drop time against a predetermined drop time.

Furthermore, said detection means are designed to detect that said injector is stuck in the open position when said drop time is shorter than said predetermined drop time.

Advantageously, said detection means comprise pressure comparison means for comparing the pressure at which said injector is supplied with fuel against a predetermined error pressure, lower than said predetermined lower pressure.

In a preferred embodiment, said detection means are designed to detect that said injector is stuck in the open position when said pressure at which said injector is supplied with fuel is lower than said predetermined error pressure.

Furthermore, the system may comprise deactivation means for deactivating said detection means when an electrical operating fault with said sensor that measures the pressure at which said injector is supplied with fuel is detected, when an electrical operating fault with said injector is detected, when an electrical operating fault with said pump is detected, or when said pump is deactivated.

In other words, the detection means detect a fault with the operation of the injector when it is supposed to close but remains stuck open. It is therefore possible to detect defective operation of such a catalytic particulate filter regeneration system and thus be able to avoid failures of such a system. Vehicle occupant safety is thus improved.

Advantageously, said detection means are designed to stop any phase of regenerating the catalytic particulate filter when said detection means detect that said injector is stuck in the open position.

The risks of an accident being caused by fuel being injected at excessively high temperatures are thus reduced.

According to another aspect of the invention, there is also proposed a method for regenerating a catalytic particulate filter located in the exhaust line of a diesel engine, characterized in that the fact that said injector is stuck in the open position is detected from the pressure at which fuel is supplied to a controlled fuel injector located upstream of the catalytic particulate filter and supplied with fuel by a pump.

Further objects, features and advantages of the invention will become apparent from reading the following description of a number of nonlimiting examples given with reference to the attached drawings in which:

FIG. 1 is a block diagram of a first embodiment of a system according to one aspect of the invention;

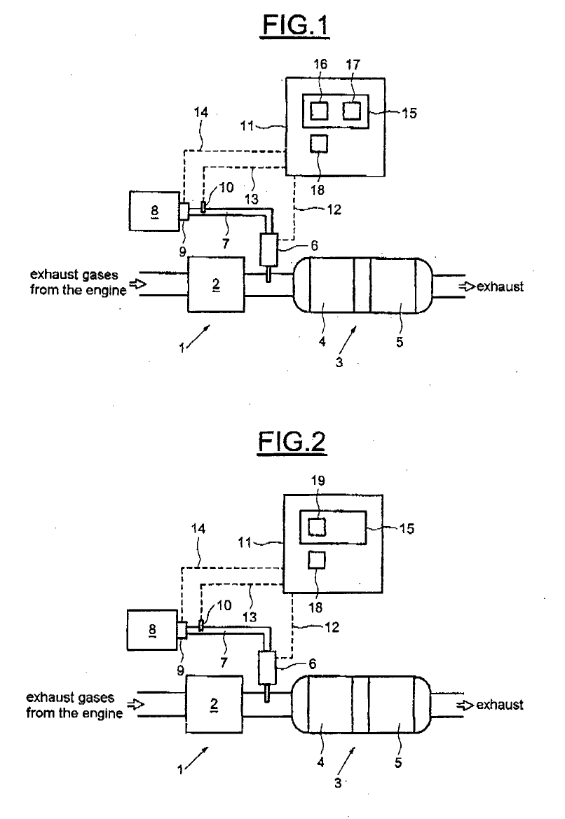

FIG. 2 is a block diagram of a second embodiment of a system according to one aspect of the invention; and

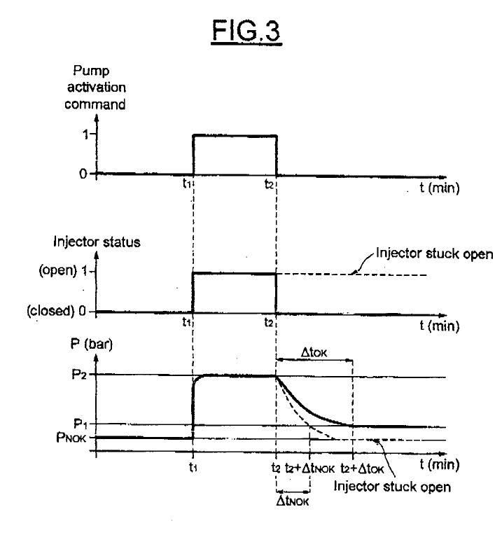

FIG. 3 is a block diagram illustrating the pump activation status, the injector status and the pressure at which the injector is supplied with fuel during normal operation and when the injector is stuck in the open position.

In FIG. 1, the exhaust line 1 of a motor vehicle equipped with a diesel engine comprises an oxidation catalytic device 2 for oxidizing hydrocarbons and carbon monoxide.

The exhaust line also comprises a catalytic particulate filter 3 comprising an oxidation catalytic converter 4 and a particulate filter 5.

An injector 6 sprays fuel upstream of the oxidation catalytic converter 4. The oxidation catalytic converter 4 is periodically called upon during the phases in which the particulate filter 5 is being regenerated, to create heat to regenerate the particulate filter 5. Injecting fuel via the injector 6 allows the temperature of the exhaust gases to be raised. The injector 6 is supplied with fuel by a line 7 connecting the injector 6 to a fuel tank 8. A fuel pump 9 supplies the injector 6 with pressurized fuel along the line 7.

The fuel supply line 7 is equipped with a sensor 10 for measuring the pressure P at which the injector 6 is supplied with fuel.

The injector 6, the sensor 10 and the pump 9 are connected to an electronic control unit 11 by connections 12, 13 and 14, respectively.

The electronic control unit 11 comprises a detection module 15 for detecting that the injector 6 is stuck in the open position on the basis of the pressure P at which the injector 6 is supplied with fuel as measured by the pressure sensor 10.

The detection module 15 comprises a time determining module 16 for determining a time Δt taken for the pressure P at which the injector 6 is supplied with fuel to drop from a predetermined upper pressure P₂ to a predetermined lower pressure P₁. The predetermined lower pressure P₁ is lower than the predetermined upper pressure P₂ (FIG. 3).

The detection module 15 comprises time comparison means 17 for comparing said drop time Δt against a predetermined drop time Δtₒₖ.

The detection module 15 detects that said injector 6 is stuck in the open position when said drop time Δt is shorter than said predetermined drop time Δtₒₖ because such a pressure drop that occurs more swiftly than in normal operation indicates that the injector is stuck in the open position (FIG. 3).

Furthermore, the system comprises a deactivation module 18 for deactivating the detection module 15 when an electrical operating fault with the sensor 10 that measures the pressure P at which the injector 6 is supplied with fuel is detected, when an electrical operating fault with the injector 6 is detected, when an electrical operating fault with the pump 9 is detected, or when the pump 9 is deactivated.

This is because when such events are detected, the diagnosis regarding operation of the injector is somewhat unreliable.

Furthermore, the detection means 15 stop any phase of regenerating the catalytic particulate filter 3 when they detect that said injector 6 is stuck in the open position.

FIG. 2 depicts a system similar to that of FIG. 1, without the modules 16 and 17 for determining the time taken and for comparing the times. The system further comprises a pressure comparison module 19 for comparing the pressure P at which said injector 6 is supplied with fuel against a predetermined error pressure Pₙₒₖ lower than the lower predetermined pressure P₁ (FIG. 3).

The detection means 15 detect that the injector 6 is stuck in the open position when the pressure P at which the injector 6 is supplied with fuel is lower than the predetermined error pressure Pₙₒₖ (FIG. 3).

Of course, the system could comprise the two aforementioned facilities for detecting that the injector 6 is stuck in open.

FIG. 3 is a schematic diagram of the change in the pressure P at which the injector 6 is supplied with fuel as a function of the activation and deactivation of the pump 9 that supplies the injector 6 with fuel. The injector status, open or closed, is also depicted.

At a moment t₁, activation of the pump 9 is commanded. Instantaneously, the pressure P at which the injector 6 is supplied with fuel switches from the value P₁ to the value P₂, and the injector 6 switches from a closed status 0 to an open status 1.

The pressure P at which the injector 6 is supplied with fuel is measured by the sensor 10 that measures the fuel pressure P in the line 7. For example, the value P₁ is of the order of 3 bar, the value P₂ of the order of 5.5 bar, and the value Pₙₒₖ ranges between 1 and 2 bar.

The pressure P at which the injector 6 is supplied with fuel remains stable at the value P₂ until the moment t₂ when deactivation of the fuel pump 9 is commanded.

When the injector 6 is operating correctly, the pressure P at which the injector 6 is supplied with fuel decreases for a length of time Δtₒₖ until it reaches the value P₁.

The portion of the curve represented in dotted line illustrates a situation whereby the injector 6 is stuck open. The pressure P at which the injector 6 is supplied with fuel decreases from the value P₂ to the value Pₙₒₖ and becomes stabilized at that value.

It therefore passes through the value P₁ at a moment t₂+Δtₙₒₖ, where Δtₙₒₖ is shorter than Δtₒₖ.

The present invention makes it possible to detect that an injector positioned upstream of a catalytic particulate filter is stuck in the open position, and thus improves the control over the running of the filter regeneration phases.

1-9. (canceled)

10. A system for regenerating a catalytic particulate filter located in an exhaust line of a diesel engine, comprising:
an electronic control unit;
a controlled fuel injector located upstream of the catalytic particulate filter and supplied with fuel by a controlled pump;
a sensor configured to measure pressure at which the injector is supplied with fuel; and
means for detecting that the injector is stuck in an open position based on a pressure at which the injector is supplied with fuel.

11. The system as claimed in claim 10, in which the means for detecting comprises time determining means for determining the time it takes for the pressure at which the injector is supplied with fuel to drop from a predetermined upper pressure to a predetermined lower pressure.

12. The system as claimed in claim 11, in which the means for detecting comprises time comparison means for comparing the drop time against a predetermined drop time.

13. The system as claimed in claim 12, in which the means for detecting detects that the injector is stuck in the open position when the drop time is shorter than the predetermined drop time.

14. The system as claimed in claim 10, in which the means for detecting comprises pressure comparison means for comparing the pressure at which the injector is supplied with fuel against a predetermined error pressure lower than the predetermined lower pressure.

15. The system as claimed in claim 14, in which the means for detecting detects that the injector is stuck in the open position when the pressure at which the injector is supplied with fuel is lower than the predetermined error pressure.

16. The system as claimed in claim 10, further comprising:
deactivation means for deactivating the means for detecting when an electrical operating fault with the sensor that measures the pressure at which the injector is supplied with fuel is detected, when an electrical operating fault with the injector is detected, when an electrical operating fault with the pump is detected, or when the pump is deactivated.

17. The system as claimed in claim 10, in which the means for detecting stops any phase of regenerating the catalytic particulate filter when the means for detecting detects that the injector is stuck in the open position.

18. A method for regenerating a catalytic particulate filter located in an exhaust line of a diesel engine, comprising:
detecting that the injector is stuck in a open position from a pressure at which fuel is supplied to a controlled fuel injector located upstream of the catalytic particulate filter and supplied with fuel by a pump.
